(19) United States
(12) Patent Application Publication
(10) Pub. No.: US 2025/0065513 A1
(43) Pub. Date: Feb. 27, 2025

(54) FORCE DETECTION DEVICE AND ROBOT

(71) Applicant: FANUC CORPORATION, Minamitsuru-gun, Yamanashi (JP)

(72) Inventor: Ryoue TOUMATSU, Yamanashi (JP)

(73) Assignee: FANUC CORPORATION, Minamitsuru-gun, Yamanashi (JP)

(21) Appl. No.: 18/728,172

(22) PCT Filed: Feb. 25, 2022
(86) PCT No.: PCT/JP2022/007835

§ 371 Date: Jul. 11, 2024

(51) Int. Cl. B25J 13/08

(52) U.S. Cl. CPC B25J 13/085

(57) ABSTRACT

A force detection device includes: a first attachment part fixed to a first surface to be attached; a second attachment part fixed to a second surface to be attached, the load fluctuation of which is larger than that of the first surface to be attached; and a force sensor body fixed between the first and second attachment part. The first attachment part includes: a planar or flange-shaped first portion fixed to one end surface of the force sensor body; a columnar second portion, one end of which is connected to the first portion on the opposite side from the force sensor body; and a third portion provided to the other end of the second portion and fixed to the first surface to be attached. A gap in the axial direction of the second portion is formed between the first and third portion.

### TECHNICAL FIELD

The present disclosure relates to a force detection device and a robot.

### BACKGROUND

There are well-known force detectors provided with a gap between a force sensor body and an attachment part so as not to be readily affected by strain on the attaching site (refer to, for example, Japanese Unexamined Patent Application, Publication No. 2021-41482). Even if the surface to which a force sensor is attached is strained and stress thus acts on the attachment part attached to the surface, the force sensor body can be less affected by stress generated by strain, corrugation, etc. on the attachment surface because the force transmission path becomes longer due to the gap.

### SUMMARY

It is a force detection device comprising: a first attachment part fixed to a first surface to be attached; a second attachment part fixed to a second surface to be attached, a load fluctuation of which is larger than that of the first surface to be attached; and a force sensor body fixed between the first attachment part and the second attachment part, wherein the first attachment part comprises a planar or flange-shaped first portion fixed to one end surface of the force sensor body, a columnar second portion, one end of which is connected to the first portion on an opposite side from the force sensor body, and a third portion that is provided at an other end of the second portion and is fixed to the first surface to be attached, a gap in an axial direction of the second portion is formed between the first portion and the third portion, and the second attachment part is formed in a shape of a plane fixed to an other end surface of the force sensor body, the plane having a higher stiffness than the third portion.

### BRIEF DESCRIPTION OF DRAWINGS

FIG. 1 is a side view showing a robot including a force detection device according to an embodiment of the present disclosure.

FIG. 2 is a partial side view showing a base and the force detection device of the robot in FIG. 1.

FIG. 3 is a plan view showing an adaptor included in the robot in FIG. 1.

FIG. 4 is a graph showing the relationship between the thickness of the adaptor and the amount of error in the force detection device.

FIG. 5 is a table showing the relationship among various types of robots, ratio α, and thickness t1 of the adaptor.

### DETAILED DESCRIPTION OF EMBODIMENTS

A force detection device 1 and a robot 100 according to an embodiment of the present disclosure will now be described with reference to the drawings.

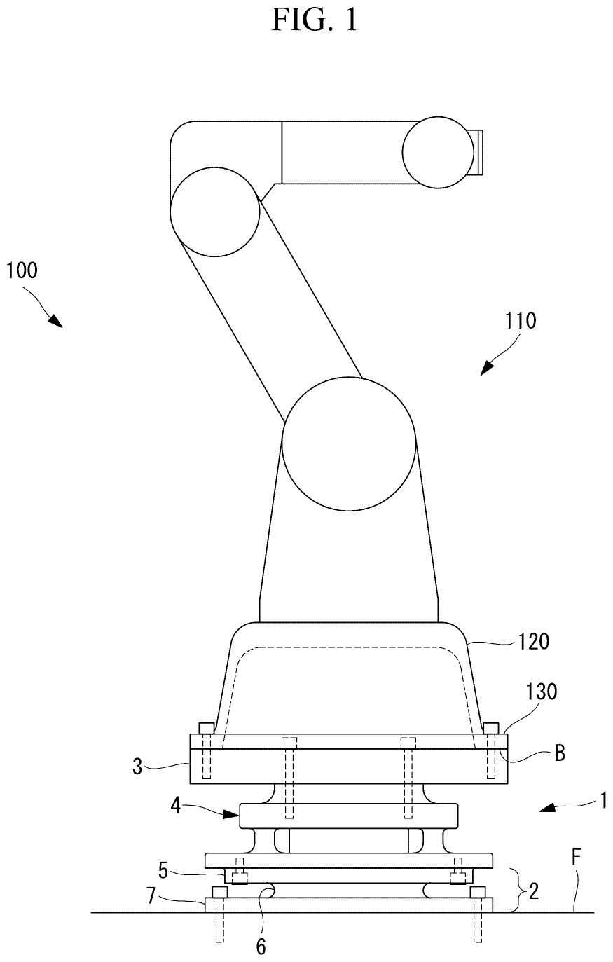

As shown in FIG. 1, the robot 100 according to this embodiment includes a vertical 6-axis multi-joint robot body 110 and the force detection device 1 fixed to a floor surface (first surface to be attached) F.

The force detection device 1 includes: a first attachment part 2 fixed to the floor surface F; a second attachment part to which a bottom surface (second surface to be attached) B of an installation flange 130 provided on a base 120 of the robot body 110 is fixed; and a force sensor body 4 fixed between the first attachment part 2 and the second attachment part. The force sensor body 4 includes a strain detector, such as an electrical resistance type strain gage (not shown in the figure), for detecting strain of a force sensor body caused by an external force. The force sensor body 4 is a 6-axis sensor that detects the magnitude and the direction of force applied to the force sensor body.

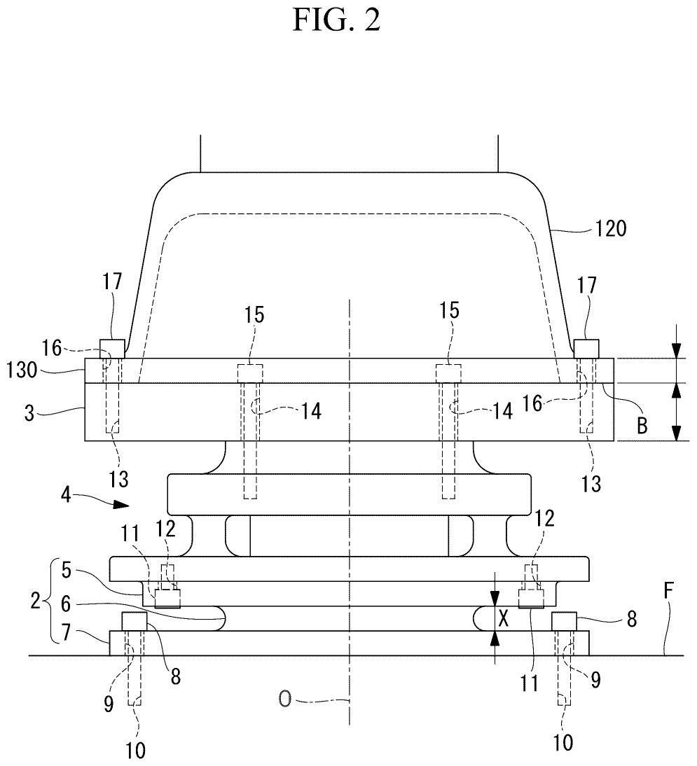

The first attachment part 2 is formed by processing a casting. The first attachment part 2 may be formed by machining a metal block or may be formed by any other method. The first attachment part 2 may be formed as a single component in order to curb the manufacturing cost. As shown in FIG. 2, the first attachment part 2 includes a first portion 5, a second portion 6, and a third portion 7 in that order from the top.

The first portion 5 has an upper surface to which the force sensor body 4 is fixed and is formed in a planar shape extending at least in the horizontal direction.

The second portion 6 is formed in a columnar shape extending at least in the downward direction from a lower surface of the first portion 5.

The third portion 7 is formed in a planar shape extending at least in the horizontal direction at a lower portion of the second portion 6 and is fixed to the floor surface F.

As shown in FIG. 2, a gap X in the up/down direction is formed between the first portion 5 and the third portion 7. In other words, the second portion 6 is formed to have a constriction that is smaller in the horizontal diameter in comparison with the first portion 5 and the third portion 7. In this embodiment, the gap X formed by the constriction between the first portion 5 and the third portion 7 extends over the whole circumference about a central axis O.

The third portion 7 of the first attachment part 2 includes four through-holes 9 into which bolts 8 are inserted at predetermined circumferential positions about the central axis O. The through-holes 9 are arranged on the same circumference centered on the central axis O at positions horizontally further outward than the first portion 5.

Each of the through-holes 9 is provided at a position near an external outline of the third portion 7. The position near the external outline refers to as a position further outward than the midpoint of the straight line connecting the central axis O and an external edge in the third portion 7. As shown in FIG. 2, the first attachment part 2 including the third portion 7 can be fixed to the floor surface F as a result of the bolts 8 inserted into the through-holes 9 being tightened in screw holes 10 formed in the floor surface F.

The first portion 5 of the first attachment part 2 includes through-holes 12 for fixing the first attachment part 2 and the force sensor body 4 by using a plurality of bolts 11 at positions near an external outline close to an outer perimeter of the first portion 5.

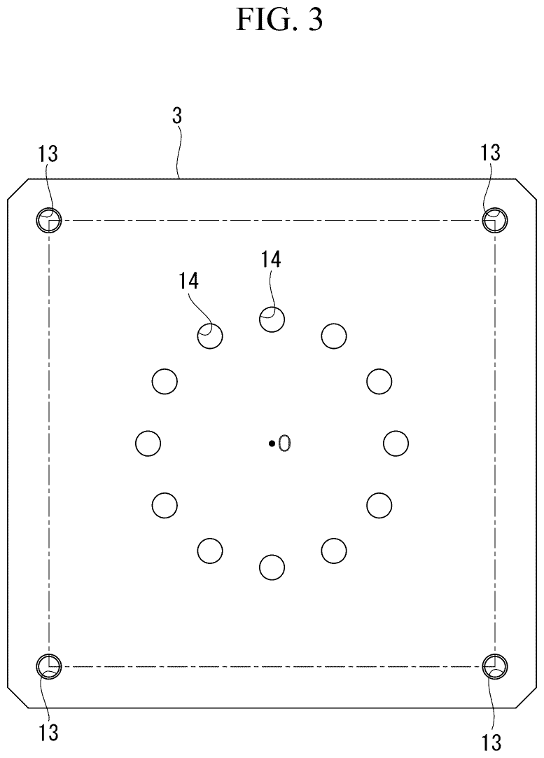

The second attachment part is a planar adaptor 3 that is fixed to an upper surface of the force sensor body 4 and that has higher stiffness than the third portion 7. As shown in FIG. 3, the adaptor 3 is formed in the shape of a plane that is substantially square in plan view and has an external shape equivalent to an outline shape of the bottom surface B of the base 120 and includes four screw holes 13 at positions near the external outline of the adaptor 3 on the same circumference centered on the central axis O. In addition, the adaptor 3 includes a plurality of through-holes 14 that are formed at positions between the central axis O and the screw holes 13 so as to be spaced apart in the circumferential direction and is fixed to the upper surface of the force sensor body 4 by using bolts 15 made to pass through the respective through-holes 14.

In the robot 100 according to this embodiment, the base 120 of the robot body 110 is shaped like a cup placed face down, which is internally hollow and open at the bottom surface B, and includes the installation flange 130 for fixing the base 120 to the adaptor 3 at four corners. The installation flange 130 includes four through-holes 16 arranged at positions that correspond to the four screw holes 13 of the adaptor 3 serving as the second attachment part in a state in which the bottom surface B of the installation flange 130 provided in the base 120 is in close contact with an upper surface of the adaptor 3.

The robot body 110 is fixed to the force detection device 1 by tightening bolts 17 that have been made to pass through the respective through-holes 16 to the respective screw hole 13 of the adaptor 3.

In this case, the robot 100 according to this embodiment is shaped such that a ratio a, which is the ratio of the sum of a thickness dimension t1 of the adaptor 3 serving as the second attachment part and a thickness dimension t2 of the installation flange 130 with respect to a size A of the installation flange 130, is equal to or larger than a predetermined threshold value Th, as denoted by the expression below:

$$α = ( t 1 + t 2 ) / A \geq Th$$

In addition, the thickness dimension t1 of the adaptor 3 is larger than the thickness dimension t2 of the installation flange 130.

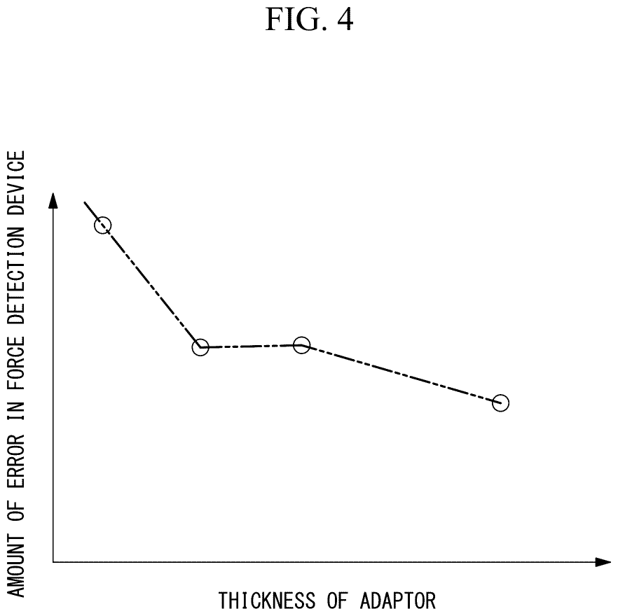

FIG. 4 shows a graph representing the amount of error in the force detection device 1 calculated by analysis with a change in the thickness dimension t1 of the adaptor 3. This graph indicates that when the thickness dimension t1 of the adaptor 3 becomes larger than a predetermined value, the amount of error in the force detection device 1 significantly decreases.

Also, it is considered that even with a smaller thickness of the adaptor 3, the same effect is produced if the thickness dimension t2 of the installation flange 130 of the robot body 110 fixed to the adaptor 3 is large.

Therefore, it is possible to significantly decrease the amount of error in the force detection device 1 by forming a shape satisfying that the ratio o of the sum of the thickness dimension t1 of the adaptor 3 and the thickness dimension t2 of the installation flange 130 with respect to the size A of the installation flange 130 is equal to or larger than the predetermined threshold value Th. That is, the larger the thickness dimension t2 of the installation flange 130 of the robot body 110, the larger the set thickness dimension t1 of the adaptor 3, or the smaller the set size A of the installation flange 130, the more profound the effect for decreasing the amount of error.

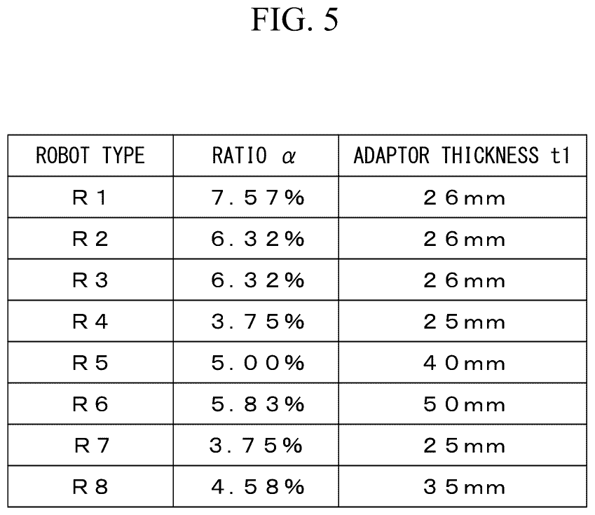

Here, if, for example, the perimeter of the rectangle (shown by chain lines in FIG. 3) formed by connecting the centers of the four bolts 17 that fix the installation flange 130 and the adaptor 3 is employed as the size A of the installation flange 130, the aforementioned predetermined threshold value Th is 4%. FIG. 5 shows the relationship among various robots R1 to R8, the ratio α, and the thickness dimension t1 of the adaptor 3.

According to this, it was found that the amount of error in the force detection device 1 can be reduced by configuring many of the robots 100 so as to satisfy the aforementioned relationship. Also, even with a robot 100 having a ratio α of 4% or less, it was possible to decrease the amount of error in the force detection device 1 by adjusting the thickness dimension t1 of the adaptor 3 so as to achieve a ratio of 4% or more.

According to the force detection device 1 and the robot 100 of this embodiment with the aforementioned configuration, the gap X in the up/down direction (gap in the axial direction of the second portion 6) is formed between the third portion 7 fixed to the floor surface F and the first portion 5 fixed to the force sensor body 4. Because of this, the path along which a force is transmitted from the outer perimeter of the third portion 7 to the first portion 5 becomes longer by the gap X.

In short, according to this embodiment, when the bolts 8, which are made to pass through the through-holes 9 provided in the third portion 7 and are then tightened to the screw holes 10 provided in the floor surface F, are tightened, the force sensor body 4 can be less affected by stress that is generated on the third portion 7 by strain on the floor surface F, corrugation on the surface, etc. By doing so, it is possible to enhance the detection accuracy of a force acting on the robot body 110, despite strain and corrugate on the floor surface F.

In addition, according to the robot 100 of this embodiment, the adaptor 3 for fixing the installation flange 130 of the base 120 of the robot body 110 is formed in the shape of a plane having a sufficiently large thickness dimension. By doing so, the stiffness of the adaptor 3 can be increased sufficiently in comparison with the first attachment part 2, which is less affected by strain on the floor surface F by virtue of the gap X.

As a result, even when the operation of the robot body 110 results in large load fluctuation acting on the adaptor 3 serving as the second attachment part, strain of the force sensor body 4 in an unexpected direction can be prevented. That is, despite that the base 120 of the robot body 110 is formed in the shape of a cup with relatively low stiffness due to an opening at the bottom surface B of the installation flange 130, deformation of the base 120 resulting from large load fluctuation can be suppressed by fixing the installation flange 130 to the adaptor 3 with a large thickness dimension. This provides an advantage in that a decrease in force detection accuracy with the force sensor body 4 can be prevented.

Note that, in this embodiment, the installation flange 130 of the base 120 of the robot body 110 is connected to the adaptor 3 with the four bolts 17, and the perimeter of the rectangle formed by connecting the centers of the four bolts 17 is employed as the size of the installation flange 130. Instead of this, the length of a diagonal line of the rectangle may be employed as the size A of the installation flange 130.

Furthermore, in the case where the installation flange 130 is fixed to the adaptor 3 with three bolts 17, the perimeter of the triangle formed by connecting the centers of the three bolts 17 may be employed as the size A of the installation flange 130. In addition, the circumference or diameter dimension of the circle passing through the centers of the three bolts 17 may be set as the size A of the installation flange 130.

1. A force detection device comprising:
a first attachment part fixed to a first surface to be attached;
a second attachment part fixed to a second surface to be attached, a load fluctuation of which is larger than that of the first surface to be attached; and
a force sensor body fixed between the first attachment part and the second attachment part,
wherein the first attachment part comprises a planar or flange-shaped first portion fixed to one end surface of the force sensor body, a columnar second portion, one end of which is connected to the first portion on an opposite side from the force sensor body, and a third portion that is provided at an other end of the second portion and is fixed to the first surface to be attached,
a gap in an axial direction of the second portion is formed between the first portion and the third portion, and
the second attachment part is formed in a shape of a plane fixed to an other end surface of the force sensor body, the plane having a higher stiffness than the third portion.

2. The force detection device according to claim 1,
wherein the second surface to be attached is provided on an installation flange fixed to the second attachment part in a state in which the installation flange is in close contact with a surface of the second attachment part, and
the second attachment part has a larger thickness dimension than the installation flange.

3. The force detection device according to claim 2,
wherein a ratio of a sum of the thickness dimension of the installation flange and the thickness dimension of the second attachment part with respect to a size of the installation flange is equal to or larger than a predetermined threshold value.

4. The force detection device according to claim 2,
wherein the first surface to be attached is a floor surface, and
the second surface to be attached is a bottom surface of the installation flange provided on a base of a robot body.

5. The force detection device according to claim 4,
wherein the second attachment part has an external shape equivalent to an outline shape of the bottom surface.

6. A robot comprising:
the force detection device according to claim 4; and
the robot body in which the bottom surface is fixed to the second attachment part of the force detection device.

7. A robot comprising:
a force detection device; and
a robot body having an installation flange on a bottom surface thereof, the installation flange fixed to the force detection device,
wherein the force detection device comprises a first attachment part fixed to a floor surface, a second attachment part fixed to the installation flange, and a force sensor body fixed between the first attachment part and the second attachment part, and
a ratio of a sum of a thickness dimension of the installation flange and a thickness dimension of the second attachment part with respect to a size of the installation flange is equal to or larger than a predetermined threshold value.

8. The robot according to claim 7,
wherein the first attachment part comprises a planar or flange-shaped first portion fixed to one end surface of the force sensor body, a columnar second portion, one end of which is connected to the first portion on an opposite side from the force sensor body, and a third portion that is provided at an other end of the second portion and is fixed to the floor surface, and
a gap in an axial direction of the second portion is formed between the first portion and the third portion.
